(19) United States
(12) Patent Application Publication
(10) Pub. No.: US 2010/0122528 A1
(43) Pub. Date: May 20, 2010

(54) Hydraulic system having regeneration and supplemental flow

(76) Inventors: Matthew J. Beschorner, Plainfield, IL (US); Aleksandar M. Egelja, Naperville, IL (US); Mikhail A. Sorokine, Naperville, IL (US); Vivek K. Dubey, Vernon Hills, IL (US)

Correspondence Address: CATERPILLAR/FINNEGAN, HENDERSON, L.L.P., 901 New York Avenue, NW, WASHINGTON, DC, 20001-4413, US

(21) Appl. No.: 12/292,430

(22) Filed: Nov. 19, 2008

(51) Int. Cl. F15B 13/04; F15B 11/00

(52) U.S. Cl. 60/424; 60/464; 60/327; 91/524

(57) ABSTRACT

A hydraulic system for a machine is disclosed. The hydraulic system may have a pump, a tank, a first actuator with a head-end and a rod-end, and a first valve arrangement configured to control fluid flow from the pump to the first actuator and from the first actuator to the tank. The hydraulic system may also have a second actuator with a head-end and a rod-end, and a second valve arrangement configured to control fluid flow from the pump to the second actuator and from the second actuator to the tank. The hydraulic system may further have a third valve arrangement fluidly connected between the first and second valve arrangements to receive pressurized fluid from the pump in parallel with the first and second valve arrangements. The third valve arrangement may be configured to facilitate fluid regeneration of and supplemental flow to at least one of the first and second actuators.

### TECHNICAL FIELD

The present disclosure relates generally to a hydraulic system, and more particularly, to a hydraulic system having regeneration and supplemental flow.

### BACKGROUND

Hydraulic machines such as, for example, dozers, loaders, excavators, motor graders, and other types of heavy equipment use one or more hydraulic actuators to accomplish a variety of tasks. These actuators are fluidly connected to a pump of the machine that provides pressurized fluid to chambers within the actuators. As the pressurized fluid moves into or through the chambers, the pressure of the fluid acts on surfaces of the chambers to affect movement of the actuators and a connected work tool. When the pressurized fluid is drained from the chambers, it is returned to a low pressure sump of the machine.

One problem associated with this type of hydraulic arrangement involves efficiency. In particular, the fluid draining from the actuator chambers to the sump often has a pressure greater than a pressure of the fluid already within the sump, especially when the actuators are moving in a direction aligned with the pull of gravity (i.e., when actuator movement is being assisted by a weight of the tool and any associated load). As a result, the higher pressure fluid draining into the sump still contains some energy that is wasted upon entering the low pressure sump. This wasted energy reduces the efficiency of the hydraulic system.

Another problem associated with the hydraulic arrangement described above involves flow capacity. That is, the various valves and passageways of the system that control flow to and from the actuators place restrictions on fluid supplying and draining from the actuators. As a result of the restrictions, the flow to and from the actuators may be limited, thereby causing the actuators to move slower than desired.

One attempt to alleviate the problems described above is disclosed in U.S. Patent Application Publication No. 2007/0186548 (the '548 publication) by Smith et al. published on Aug. 16, 2007. Specifically, the '548 publication discloses a hydraulic system including a first actuator, a second actuator, a pump, and a tank. The hydraulic system further includes a first arrangement of valves associated with control of fluid flow from the pump to the first actuator and from the first actuator to the tank, and a second arrangement of valves associated with control of fluid flow from the pump to the second actuator and from the second actuator to the tank. The hydraulic system also includes an independent metering valve connected between the first and second arrangements of valves. During a retraction of the first actuator, the independent metering valve is opened to allow fluid forced from the first actuator to enter and move the second actuator during a regeneration event, and/or to enter and be stored within an accumulator for later use. The fluid stored within the accumulator may then be directed to a suction side of the pump to selectively supplement pump flow that is directed to the first and second actuators.

Although the hydraulic system described in the '548 publication may help improve efficiency and flow capacity by implementing regeneration and supplementing pump flow, it may be suboptimal. Specifically, the hydraulic system may utilize a large number of components to supports its operations, thereby increasing a cost and a complexity of the system. Further, because the supplemental flow from the accumulator is directed into the pump before passing to the first and second actuators, the flow may still be restricted and be flow limited by the number of valves and passageways within the system.

The disclosed hydraulic system is directed to overcoming one or more of the problems set forth above.

### SUMMARY

In one aspect, the present disclosure is directed to a hydraulic system. The hydraulic system may include pump, a tank, a first actuator having a head-end and a rod-end, and a first valve arrangement configured to control fluid flow from the pump to the first actuator and from the first actuator to the tank. The hydraulic system may also include a second actuator having a head-end and a rod-end, and a second valve arrangement configured to control fluid flow from the pump to the second actuator and from the second actuator to the tank. The hydraulic system may further include a third valve arrangement fluidly connected between the first and second valve arrangements to receive pressurized fluid from the pump in parallel with the first and second valve arrangements, the third valve arrangement being configured to facilitate fluid regeneration of and supplemental flow to at least one of the first and second actuators.

In another aspect, the present disclosure is directed to a method of operating a hydraulic system. The method may include pressurizing a fluid, directing a first flow of the pressurized fluid to move a first actuator, and directing a second flow of the pressurized fluid to move a second actuator. The method may further include directing a third flow of the pressurized fluid in parallel with at least one of the first and second flows of pressurized fluid to move at least one of one of the first and second actuators at an increased velocity, and directing pressurized fluid from the first actuator to the second actuator.

### BRIEF DESCRIPTION OF THE DRAWINGS

FIG. 1 is a diagrammatic illustration of an exemplary disclosed machine; and

FIG. 2 is a schematic illustration of an exemplary disclosed hydraulic system that may be used in conjunction with the machine of FIG. 1;

FIG. 3 is a schematic illustration of an exemplary disclosed hydraulic system that may be used in conjunction with the machine of FIG. 1;

FIG. 4 is a schematic illustration of an exemplary disclosed hydraulic system that may be used in conjunction with the machine of FIG. 1; and

FIG. 5 is a schematic illustration of an exemplary disclosed hydraulic system that may be used in conjunction with the machine of FIG. 1.

### DETAILED DESCRIPTION

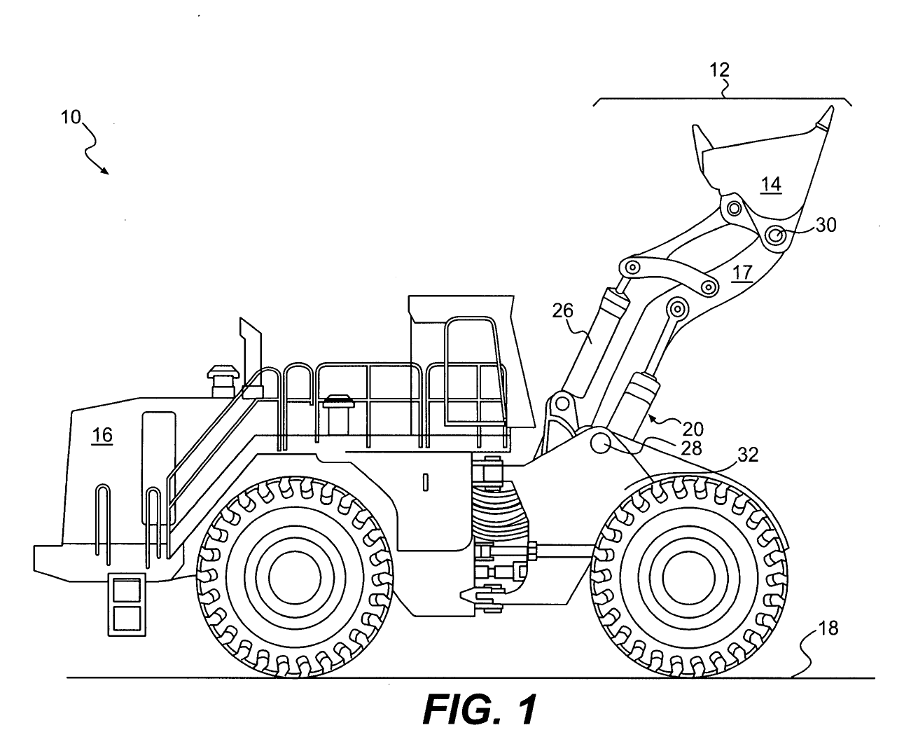

FIG. 1 illustrates an exemplary machine 10 having multiple systems and components that cooperate to accomplish a task. Machine 10 may embody a fixed or mobile machine that performs some type of operation associated with an industry such as mining, construction, farming, transportation, or any other industry known in the art. For example, machine 10 may be an earth moving machine such as a loader, an excavator, a dozer, a backhoe, a motor grader, a dump truck, or any other earth moving machine. Machine 10 may include an linkage system 12 configured to move a work tool 14, and a prime mover 16, for example a combustion engine, that provides power to linkage system 12.

Linkage system 12 may include structure affected by fluid actuators to move work tool 14. Specifically, linkage system 12 may include a boom member (i.e., a lifting member) 17 vertically pivotal about a horizontal axis 28 relative to a work surface 18 by a pair of adjacent, double-acting, hydraulic cylinders 20 (only one shown in FIG. 1). Linkage system 12 may also include a single, double-acting, hydraulic cylinder 26 connected to tilt work tool 14 relative to boom member 17 vertically about a horizontal axis 30. Boom member 17 may be pivotally connected to a frame 32 of machine 10.

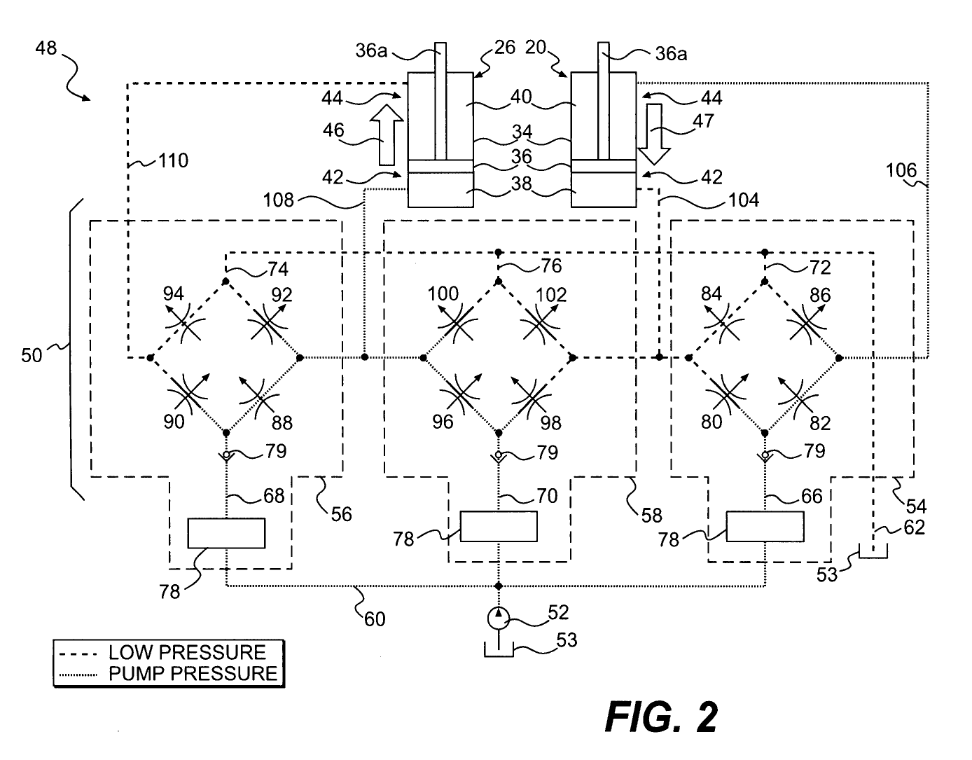

For purposes of simplicity, FIG. 2 illustrates the composition and connections of only hydraulic cylinders 20 and 26. It should be noted, however, that machine 10 may include other hydraulic actuators of similar composition connected to move the same or other structural members of linkage system 12 in a similar manner, if desired.

As shown in FIG. 2, each of hydraulic cylinders 20 and 26 may include a tube 34 and a piston assembly 36 arranged to form a first pressure chamber 38 and a second pressure chamber 40. In one example, a rod portion 36a of piston assembly 36 may extend through second pressure chamber 40. As such, second pressure chamber 40 may be associated with a rod-end 44 of its respective cylinder, while first pressure chamber 38 may be associated with an opposing head-end 42 of its respective cylinder.

First and second pressure chambers 38, 40 may each be selectively supplied with pressurized fluid and drained of the pressurized fluid to cause piston assembly 36 to displace within tube 34, thereby changing an effective length of hydraulic cylinders 20, 26. A flow rate of fluid into and out of first and second pressure chambers 38, 40 may relate to a velocity of hydraulic cylinders 20, 26, while a pressure differential between the first and second pressure chambers 38, 40 may relate to a force imparted by hydraulic cylinders 20, 26 on the associated linkage members. An expansion (represented by arrow 46) and a retraction (represented by an arrow 47) of hydraulic cylinders 20, 26 may function to assist in moving work tool 14.

To help regulate filling and draining of first and second chambers 38, 40, machine 10 may include a hydraulic system 48 having a plurality of interconnecting and cooperating fluid components. In particular, hydraulic system 48 may include valve stack 50 at least partially forming a circuit configured to receive pressurized fluid from an engine-driven pump 52 and to discharge fluid to a tank 53 or other low pressure reservoir. Valve stack 50 may include a lift valve arrangement 54, a tilt valve arrangement 56, and an auxiliary valve arrangement 58 fluidly connected to receive pressurized fluid from pump 52 in parallel fashion. In one embodiment, valve arrangements 54-58 may include bodies bolted to each other to form valve stack 50. In another embodiment, each of valve arrangements 54-58 may be stand-alone arrangements, connected only by way of fluid conduits, if desired. It is contemplated that a greater number, a lesser number, or a different configuration of valve arrangements may be included within valve stack 50, if desired. For example, a swing valve arrangement (not shown) configured to control a swinging motion of linkage system 12, one or more attachment valve arrangements (not shown), one or more travel valve arrangements, and other suitable valve arrangements may be included in valve stack 50.

Each of lift, tilt, and auxiliary valve arrangements 54-58 may regulate the motion of their associated fluid actuators. Specifically, tilt valve arrangement 54 may have elements movable to control the motion of hydraulic cylinder 20 associated with boom member 17; tilt valve arrangement 56 may have elements movable to control the motion of hydraulic cylinder 26 associated with work tool 14; and auxiliary valve arrangement 58 may have elements movable to affect the motion of any or both of hydraulic cylinders 20, 26.

Valve arrangements 54-58 may be connected to regulate flows of pressurized fluid to and from hydraulic cylinders 20, 26 via common passages. Specifically, valve arrangements 54-58 may be connected to pump 52 by way of a common supply passage 60, and to tank 53 by way of a common drain passage 62. Lift, tilt, and auxiliary valve arrangements 54-58 may be connected in parallel to common supply passage 60 by way of individual fluid passages 66, 68, 70, respectively, and in parallel to common drain passage 62 by way of individual fluid passages 72, 74, and 76, respectively. A pressure compensating valve 78 and/or a check valve 79 may be disposed within each of fluid passages 66-70 to provide a unidirectional supply of fluid having a substantially constant flow to valve arrangements 54-58. Pressure compensating valves 78 may be movable in response to a differential pressure between a flow passing position and a flow blocking position, such that a substantially constant flow of fluid is provide to valve arrangements 54-58, even when a pressure of the fluid directed to pressure compensating valves 78 varies. It is contemplated that, in some applications, pressure compensating valves 78 and/or check valves 79 may be omitted, if desired. For example, pressure compensating valve 78, in one embodiment, may be omitted from auxiliary valve arrangement 56 to increase a flow capacity thereof.

Each of lift, tilt, and auxiliary valve arrangements 54-58 may be substantially identical, and each may include four independent metering valves (IMVs). Of the four IMVs, two may be generally associated with fluid supply functions, while two may be generally associated with drain functions. For example, lift valve arrangement 54 may include a head-end supply valve 80, a rod-end supply valve 82, a head-end drain valve 84, and a rod-end drain valve 86. Similarly, tilt valve arrangement 56 may include a head-end supply valve 88, a rod-end supply valve 90, a head-end drain valve 92, and a rod-end drain valve 94. And, although not specific to a head-end or a rod-end of a particular cylinder, auxiliary valve arrangement 58 may include a first supply valve 96, a second supply valve 98, a first drain valve 100, and a second drain valve 102.

Head-end supply valve 80 may be disposed between fluid passage 66 and a fluid passage 104 leading to first chamber 38 of hydraulic cylinder 20 to regulate a flow of pressurized fluid to first chamber 38. Head-end supply valve 80 may include a variable-position, spring-biased valve element, for example a poppet or spool element, that is solenoid actuated and configured to move to any position between a first end-position, at which fluid is allowed to flow into first chamber 38, and a second end-position, at which fluid flow is blocked from first chamber 38. It is contemplated that head-end supply valve 80 may include additional or different elements such as, for example, a fixed-position valve element or any other valve element known in the art. It is also contemplated that head-end supply valve 80 may alternatively be hydraulically actuated, mechanically actuated, pneumatically actuated, or actuated in any other suitable manner. It is further contemplated that head-end supply valve 80 may be configured to allow fluid from first chamber 38 to flow through head-end supply valve 80 during a regeneration event when a pressure within first chamber 38 exceeds a pressure of pump 52 and/or a pressure of the chamber receiving the regenerated fluid.

Rod-end supply valve 82 may be disposed between fluid passage 66 and a fluid passage 106 leading to second chamber 40 of hydraulic cylinder 20 to regulate a flow of pressurized fluid to second chamber 40. Rod-end supply valve 82 may include a variable-position, spring-biased valve element, for example a poppet or spool element, that is solenoid actuated and configured to move to any position between a first end-position, at which fluid is allowed to flow into second chamber 40, and a second end-position, at which fluid is blocked from second chamber 40. It is contemplated that rod-end supply valve 82 may include additional or different valve elements such as, for example, a fixed-position valve element or any other valve element known in the art. It is also contemplated that rod-end supply valve 82 may alternatively be hydraulically actuated, mechanically actuated, pneumatically actuated, or actuated in any other suitable manner. It is further contemplated that rod-end supply valve 82 may be configured to allow fluid from second chamber 40 to flow through rod-end supply valve 82 during a regeneration event when a pressure within second chamber 40 exceeds a pressure of pump 52 and/or a pressure of the chamber receiving the regenerated fluid.

Head-end drain valve 84 may be disposed between fluid passage 104 and fluid passage 74 that leads to common drain passage 62 to regulate a flow of pressurized fluid from first chamber 38 of hydraulic cylinder 20 to tank 53. Head-end drain valve 84 may include a variable-position, spring-biased valve element, for example a poppet or spool element, that is solenoid actuated and configured to move to any position between a first end-position, at which fluid is allowed to flow from first chamber 38, and a second end-position, at which fluid is blocked from flowing from first chamber 38. It is contemplated that head-end drain valve 84 may include additional or different valve elements such as, for example, a fixed-position valve element or any other valve element known in the art. It is also contemplated that head-end drain valve 84 may alternatively be hydraulically actuated, mechanically actuated, pneumatically actuated, or actuated in any other suitable manner.

Rod-end drain valve 86 may be disposed between fluid passage 106 and fluid passage 72 that leads to common drain passage 62 to regulate a flow of pressurized fluid from second chamber 40 of hydraulic cylinder 20 to tank 53. Rod-end drain valve 86 may include a variable-position, spring-biased valve element, for example a poppet or spool element, that is solenoid actuated and configured to move to any position between a first end-position, at which fluid is allowed to flow from second chamber 40, and a second end-position, at which fluid is blocked from flowing from second chamber 40. It is contemplated that rod-end drain valve 86 may include additional or different valve elements such as, for example, a fixed-position valve element or any other valve element known in the art. It is also contemplated that rod-end drain valve 86 may alternatively be hydraulically actuated, mechanically actuated, pneumatically actuated, or actuated in any other suitable manner.

Head-end supply valve 88 may be disposed between fluid passage 68 and a fluid passage 108 leading to first chamber 38 of hydraulic cylinder 26 to regulate a flow of pressurized fluid to first chamber 38. Head-end supply valve 88 may include a variable-position, spring-biased valve element, for example a poppet or spool element, that is solenoid actuated and configured to move to any position between a first end-position, at which fluid is allowed to flow into first chamber 38, and a second end-position, at which fluid flow is blocked from first chamber 38. It is contemplated that head-end supply valve 88 may include additional or different elements such as, for example, a fixed-position valve element or any other valve element known in the art. It is also contemplated that head-end supply valve 88 may alternatively be hydraulically actuated, mechanically actuated, pneumatically actuated, or actuated in any other suitable manner. It is further contemplated that head-end supply valve 88 may be configured to allow fluid from first chamber 38 to flow through head-end supply valve 88 during a regeneration event when a pressure within first chamber 38 exceeds a pressure of pump 52 and/or a pressure of the chamber receiving the regenerated fluid.

Rod-end supply valve 90 may be disposed between fluid passage 68 and a fluid passage 110 leading to second chamber 40 of hydraulic cylinder 26 to regulate a flow of pressurized fluid to second chamber 40. Specifically, rod-end supply valve 90 may include a variable-position, spring-biased valve element, for example a poppet or spool element, that is solenoid actuated and configured to move to any position between a first end-position, at which fluid is allowed to flow into second chamber 40, and a second end-position, at which fluid is blocked from second chamber 40. It is contemplated that rod-end supply valve 90 may include additional or different valve elements such as, for example, a fixed-position valve element or any other valve element known in the art. It is also contemplated that rod-end supply valve 90 may alternatively be hydraulically actuated, mechanically actuated, pneumatically actuated, or actuated in any other suitable manner. It is further contemplated that rod-end supply valve 90 may be configured to allow fluid from second chamber 40 to flow through rod-end supply valve 90 during a regeneration event when a pressure within second chamber 40 exceeds a pressure of pump 52 and/or a pressure of the chamber receiving the regenerated fluid.

Head-end drain valve 92 may be disposed between fluid passage 108 and fluid passage 74 that leads to common drain passage 62 to regulate a flow of pressurized fluid from first chamber 38 of hydraulic cylinder 26 to tank 53. Specifically, head-end drain valve 92 may include a variable-position, spring-biased valve element, for example a poppet or spool element, that is solenoid actuated and configured to move to any position between a first end-position, at which fluid is allowed to flow from first chamber 38, and a second end-position, at which fluid is blocked from flowing from first chamber 38. It is contemplated that head-end drain valve 92 may include additional or different valve elements such as, for example, a fixed-position valve element or any other valve element known in the art. It is also contemplated that head-end drain valve 92 may alternatively be hydraulically actuated, mechanically actuated, pneumatically actuated, or actuated in any other suitable manner.

Rod-end drain valve 94 may be disposed between fluid passage 110 and fluid passage 74 leading to common drain passage 62 to regulate a flow of pressurized fluid from second chamber 40 of hydraulic cylinder 26 to tank 53. Rod-end drain valve 94 may include a variable-position, spring-biased valve element, for example a poppet or spool element, that is solenoid actuated and configured to move to any position between a first end-position, at which fluid is allowed to flow from second chamber 40, and a second end-position, at which fluid is blocked from flowing from second chamber 40. It is contemplated that rod-end drain valve 94 may include additional or different valve element such as, for example, a fixed-position valve element or any other valve elements known in the art. It is also contemplated that rod-end drain valve 94 may alternatively be hydraulically actuated, mechanically actuated, pneumatically actuated, or actuated in any other suitable manner.

First supply valve 96 may be disposed between fluid passage 70 and fluid passage 108 leading to first chamber 38 of hydraulic cylinder 26 to regulate a flow of pressurized fluid to first chamber 38. First supply valve 96 may include a variable-position, spring-biased valve element, for example a poppet or spool element, that is solenoid actuated and configured to move to any position between a first end-position, at which fluid is allowed to flow into first chamber 38, and a second end-position, at which fluid flow is blocked from first chamber 38. It is contemplated that first supply valve 96 may include additional or different elements such as, for example, a fixed-position valve element or any other valve element known in the art. It is also contemplated that first supply valve 96 may alternatively be hydraulically actuated, mechanically actuated, pneumatically actuated, or actuated in any other suitable manner. It is further contemplated that first supply valve 96 may be configured to allow fluid from first chamber 38 to flow through first supply valve 96 during a regeneration event when a pressure within first chamber 38 exceeds a pressure of pump 52 and/or a pressure of the chamber receiving the regenerated fluid.

Second supply valve 98 may be disposed between fluid passage 70 and fluid passage 104 leading to first chamber 38 of hydraulic cylinder 20 to regulate a flow of pressurized fluid to first chamber 38. Second supply valve 98 may include a variable-position, spring-biased valve element, for example a poppet or spool element, that is solenoid actuated and configured to move to any position between a first end-position, at which fluid is allowed to flow into first chamber 38, and a second end-position, at which fluid is blocked from first chamber 38. It is contemplated that second supply valve 98 may include additional or different valve elements such as, for example, a fixed-position valve element or any other valve element known in the art. It is also contemplated that second supply valve 98 may alternatively be hydraulically actuated, mechanically actuated, pneumatically actuated, or actuated in any other suitable manner. It is further contemplated that second supply valve 98 may be configured to allow fluid from first chamber 38 to flow through second supply valve 98 during a regeneration event when a pressure within first chamber 38 exceeds a pressure of pump 52 and/or a pressure of the chamber receiving the regenerated fluid.

First drain valve 100 may be disposed between fluid passage 108 and fluid passage 76 leading to common drain passage 62 to regulate a flow of pressurized fluid from first chamber 38 of hydraulic cylinder 26 to tank 53. First drain valve 100 may include a variable-position, spring-biased valve element, for example a poppet or spool element, that is solenoid actuated and configured to move to any position between a first end-position, at which fluid is allowed to flow from first chamber 38, and a second end-position, at which fluid is blocked from flowing from first chamber 38. It is contemplated that first drain valve 100 may include additional or different valve elements such as, for example, a fixed-position valve element or any other valve element known in the art. It is also contemplated that first drain valve 100 may alternatively be hydraulically actuated, mechanically actuated, pneumatically actuated, or actuated in any other suitable manner.

Second drain valve 102 may be disposed between fluid passage 104 and fluid passage 76 leading to common drain passage 62 to regulate a flow of pressurized fluid from first chamber 38 of hydraulic cylinder 20 to tank 53. Specifically, second drain valve 102 may include a variable-position. spring-biased valve element that is solenoid actuated and configured to move to any position between a first end-position, at which fluid is allowed to flow from first chamber 38, and a second end-position, at which fluid is blocked from flowing from first chamber 38. It is contemplated that second drain valve 102 may include additional or different valve elements such as, for example, a fixed-position valve element or any other valve element known in the art. It is also contemplated that second drain valve 102 may alternatively be hydraulically actuated, mechanically actuated, pneumatically actuated, or actuated in any other suitable manner.

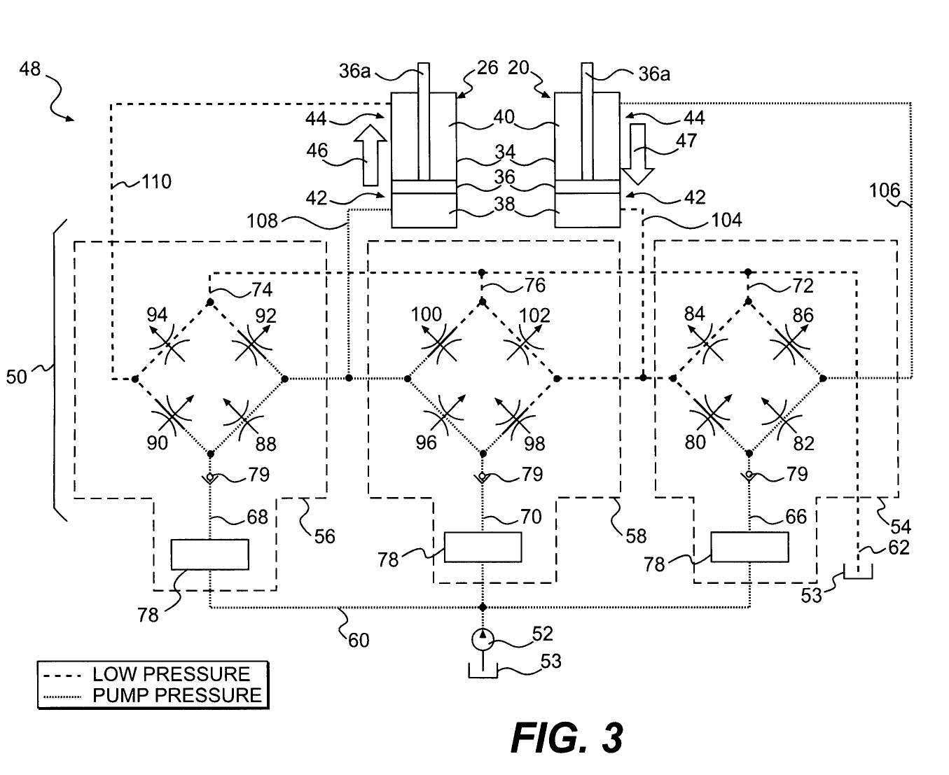

FIGS. 3-5 illustrate exemplary operations of hydraulic system 48. FIGS. 3-5 will be discussed in more detail in the following section to further illustrate the disclosed concepts.

### INDUSTRIAL APPLICABILITY

The disclosed hydraulic system may be applicable to any machine that includes multiple fluid actuators where flow capacity, cost, and efficiency are issues. The disclosed hydraulic system may provide high flow capacity by supplementing flow to and from hydraulic actuators of the system, and low cost by providing the supplemental flow with relatively few components. The disclosed hydraulic system may provide increased efficiency by facilitating cylinder-to-cylinder and in-cylinder regeneration, and by minimizing a pressure drop associated with filling or draining of the cylinders. The operation of hydraulic system 48 will now be explained.

As shown in FIG. 2, hydraulic cylinders 20 and 26 may be movable by fluid pressure in response to an operator input. In particular, fluid may be pressurized by pump 52 and selectively directed to head-end and rod-end supply valves 80, 82, 88, 90, 96, and 98. In response to an operator input to either extend or retract piston assembly 36 relative to tube 34, head-end or rod-end supply valves 80, 82, 88, 90 may be moved toward the open position to direct the pressurized fluid to the appropriate one of first and second chambers 38, 40. Substantially simultaneously, head-end or rod-end drain valves 84, 86, 92, 94 may be moved toward the open position to direct fluid from the appropriate one of the first and second chambers 38, 40 to tank 53 to create a force differential across piston assembly 36 that causes piston assembly 36 to move.

For example, if an extension of hydraulic cylinder 26 is requested (i.e., if movement of hydraulic cylinder 26 in the direction of arrow 46 is requested), head-end supply valve 88 may be moved toward the open position to direct pressurized fluid from pump 52 to first chamber 38. Substantially simultaneous to the directing of pressurized fluid to first chamber 38, rod-end drain valve 94 may be moved toward the open position to allow fluid from second chamber 40 to drain to tank 53. The high pressure within first chamber 38 and the low pressure within second chamber 40 may together create a force differential across piston assembly 36 that causes piston assembly 36 to move and extend from tube 34. During the extension of hydraulic cylinder 26, head-end drain valve 92 and rod-end supply valve 90 may be maintained in their closed positions.

If a retraction of hydraulic cylinder 20 is requested (i.e., if movement of hydraulic cylinder 20 in the direction of arrow 47 is requested), rod-end supply valve 82 may be moved toward the open position to direct pressurized fluid from pump 52 to second chamber 40. Substantially simultaneous to the directing of pressurized fluid to second chamber 40, head-end drain valve 84 may be moved toward the open position to allow fluid from first chamber 38 to drain to tank 53. The high pressure within second chamber 40 and the low pressure within first chamber 38 may together create a force differential across piston assembly 36 that causes piston assembly 36 to move and retract back into tube 34. During the retraction of hydraulic cylinder 20, head-end supply valve 80 and rod-end drain valve 86 may be maintained in their closed positions.

As shown in FIG. 3, auxiliary valve arrangement 58 may be utilized to selectively increase a velocity of hydraulic cylinders 20, 26 during an extension by facilitating supplemental flow to first chamber 38 of head-ends 42. For example, during the extension of hydraulic cylinder 26, pressurized fluid may be directed from pump 52 to first chamber 38 by way of common supply passage 60, fluid passage 68, head-end supply valve 88, and fluid passage 108. Simultaneously, pressurized fluid may be directed in parallel from pump 52 to first chamber 38 via common supply passage 60, fluid passage 70, first supply valve 96, and fluid passage 108. During the supplemented extension of hydraulic cylinder 26, head-end drain valve 92, rod-end supply valve 90, second supply valve 98, first drain valve 100, and second drain valve 102 may be maintained in their closed positions. The additional flow of fluid may help to speed up movement of hydraulic cylinder 26. The extension speed and efficiency of hydraulic cylinder 20 may be increased in a similar manner.

Auxiliary valve arrangement 58 may also be utilized to increase a velocity of hydraulic cylinders 20, 26 during a retraction by supplementing flow from head-ends 42. For example, during the retraction of hydraulic cylinder 20, fluid already within first chamber 38 may be drained to tank 53 by way of fluid passage 104, head-end drain valve 84, fluid passage 72, and common drain passage 62. Simultaneously, fluid may be directed in parallel from first chamber 38 to tank 53 via fluid passage 104, second drain valve 102, fluid passage 76, and common drain passage 62 During the supplemented retraction of hydraulic cylinder 20, head-end supply valve 80, rod-end drain valve 86, first supply valve 96, second supply valve 98, and first drain valve 100 may be maintained in their closed positions. The additional flow of fluid from first chamber 38 may help to speed up the retracting movement of hydraulic cylinder 20. The retraction speed of hydraulic cylinder 26 may be increased in a similar manner.

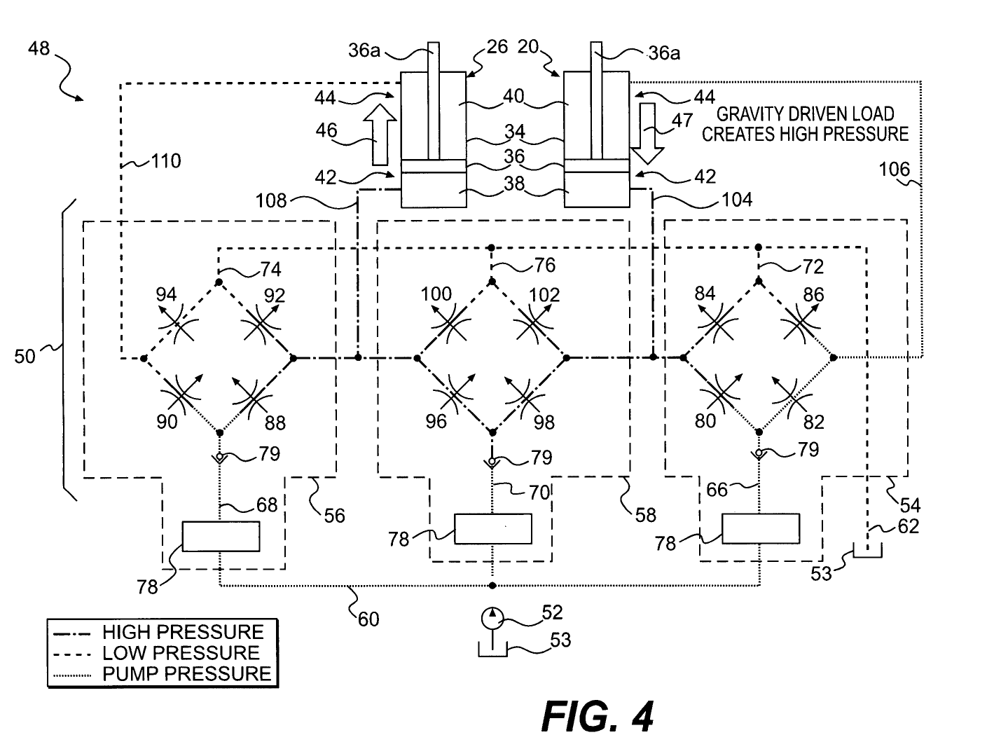

As shown in FIG. 4, auxiliary valve arrangement 58 may facilitate cylinder-to-cylinder regeneration. For example, during a retraction of hydraulic cylinder 20 aligned with the pull of gravity, the fluid exiting first chamber 38 may have a pressure as high as or even higher than the pressure imparted by pump 52. As such, rather than directing this exiting fluid to tank 53 where the energy of the highly pressurized fluid would be wasted, the pressurized fluid may instead be directed for reuse within hydraulic cylinder 26 by way of auxiliary valve arrangement 58. Specifically, the highly pressurized fluid exiting first chamber 38 of hydraulic cylinder 20 may be directed through fluid passage 104, second supply valve 98, first supply valve 96, and fluid passage 108 to first chamber 38 of hydraulic cylinder 26. Check valve 79 of auxiliary valve arrangement 58 may help inhibit undesired pump interaction with the regenerated fluid. During cylinder-to-cylinder regeneration, head-end supply valve 80, head-end drain valve 84, rod-end drain valve 86, rod-end supply valve 90, head-end supply valve 88, head-end drain valve 92, first drain valve 100, and second drain valve 102 may be at least partially, if not fully, closed. That is, in some situations, because of a volume ratio between first and second chambers 38, 40, there may be excess regenerative fluid and some of that fluid may need to be drained back to tank 53 by way of head-end drain valve 84, rod-end drain valve 86, head-end drain valve 92, first drain valve 100, and/or second drain valve 102. In other situations, the regenerated fluid may be insufficient and, in these situations, one of the supply valves of the cylinder receiving the regenerated fluid may be partially or even completely open, if desired. The fluid being directed from hydraulic cylinder 20 to hydraulic cylinder 26, because of its pressure, may cause pressure check valve 79 associated with auxiliary valve arrangement 58 to close and inhibit fluid flow in reverse direction to pump 52. In this manner, the energy associated with the fluid being forced from hydraulic cylinder 20 during gravity-assisted retraction may be at least partially recouped and utilized to move hydraulic cylinder 26. Regeneration of fluid from hydraulic cylinder 26 to hydraulic cylinder 20 may be accomplished in a similar manner.

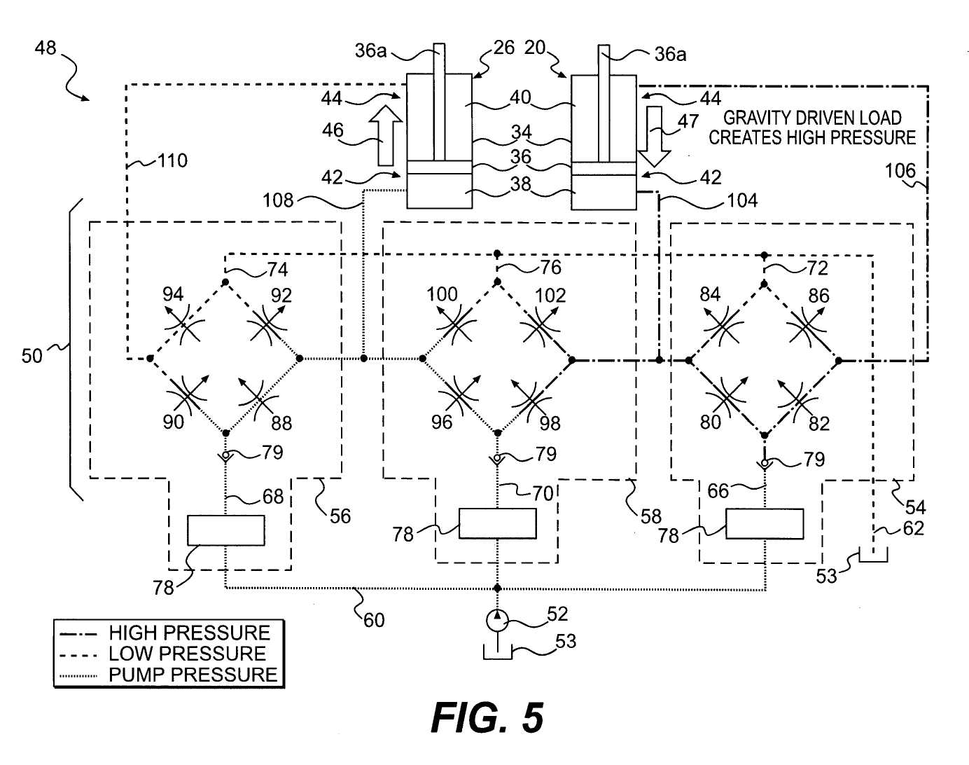

As shown in FIG. 5, auxiliary valve arrangement 58 may be further used to facilitate in-cylinder regeneration. That is, instead of or in addition to passing highly pressurized fluid from one of hydraulic cylinders 20, 26 to the other, that fluid may be reused within the same cylinder. For example, during a retraction of hydraulic cylinder 20 aligned with the pull of gravity, the highly-pressurized fluid exiting first chamber 38 may be directed through fluid passage 104, head-end supply valve 80, rod-end supply valve 82, and fluid passage 106, to second chamber 40. During in-cylinder regeneration of hydraulic cylinder 20, head-end drain valve 84 and rod-end drain valve 86 may at least partially, if not fully, closed positions. That is, in some situations, because of a volume ratio between first and second chambers 38, 40, there may be excess regenerative fluid and some of that fluid may need to be drained back to tank 53 by way of head-end drain valve 84 and/or rod-end drain valve 86. The fluid being directed from first chamber 38 of hydraulic cylinder 20 to second chamber 40 of hydraulic cylinder 26, because of its pressure, may cause check valve 79 associated with lift valve arrangement 54 to close and inhibit fluid flow to pump 52. In this manner, the energy associated with the fluid being forced from hydraulic cylinder 20 during retraction may be recouped and reutilized within hydraulic cylinder 20. In-cylinder regeneration of hydraulic cylinder 26 may be accomplished in a similar manner.

The inclusion of auxiliary valve arrangement 58 may afford several benefits. In particular, auxiliary valve arrangement 58 may facilitate supplemental flow to any of the hydraulic cylinders included within machine 10, and from those cylinders to tank 53. The supplemental flow may allow for increased velocity movements of work tool 14. Further, auxiliary valve arrangement 58 may facilitate both cylinder-to-cylinder and in-cylinder regeneration, thereby increasing an efficiency of machine 10.

It will be apparent to those skilled in the art that various modifications and variations can be made to the disclosed hydraulic system. Other embodiments will be apparent to those skilled in the art from consideration of the specification and practice of the disclosed hydraulic system. For example, although head-ends 42 of hydraulic cylinders 20, 26 are shown and described as being connected to receive supplemental flow from pump 52 by way of auxiliary valve arrangement 58, one or both of hydraulic cylinders 20, 26 could be connected in an inverse manner such that the supplemental flow is alternatively directed to rod-ends 44, if desired. Further, although pre-pressure compensating valves are described as being included in one exemplary embodiment, it is contemplated that post-compensating valves, makeup valves, relief valves, bypass valves, and other commonly known elements may additionally or alternatively be included within hydraulic system 48, if desired. It is intended that the specification and examples be considered as exemplary only, with a true scope being indicated by the following claims and their equivalents.

What is claimed is:

1. A hydraulic system, comprising:
a pump;
a tank;
a first actuator having a head-end and a rod-end;
a first valve arrangement configured to control fluid flow from the pump to the first actuator and from the first actuator to the tank;
a second actuator having a head-end and a rod-end;
a second valve arrangement configured to control fluid flow from the pump to the second actuator and from the second actuator to the tank; and
a third valve arrangement fluidly connected between the first and second valve arrangements to receive pressurized fluid from the pump in parallel with the first and second valve arrangements, the third valve arrangement being configured to facilitate fluid regeneration of and supplemental flow to at least one of the first and second actuators.

2. The hydraulic system of claim 1, further including:
a common supply passage connected to direct pressurized fluid from the pump to each of the first, second, and third valve arrangements in parallel; and
a common drain passage connected to direct fluid from each of the first, second, and third valve arrangements to the tank in parallel.

3. The hydraulic system of claim 1, wherein the third valve arrangement is configured to selectively facilitate fluid regeneration of and supplemental flow to both of the first and second actuators.

4. The hydraulic system of claim 1, wherein each of the first and second valve arrangements includes a plurality of independent metering valves.

5. The hydraulic system of claim 4, wherein each of the first and second valve arrangements includes:
a first supply valve associated with the head-end;
a first drain valve associated with the head-end;
a second supply valve associated with the rod-end; and
a second drain valve associated with the rod-end.

6. The hydraulic system of claim 5, wherein the third valve arrangement is substantially identical to each of the first and second valve arrangements and includes:
a first supply valve;
a first drain valve;
a second supply; and
a second drain valve.

7. The hydraulic system of claim 6, wherein:
the head-end of the first actuator is fluidly connected in parallel to the first supply and first drain valves of the first and third valve arrangements;
the rod-end of the first actuator is fluidly connected in parallel to the second supply and second drain valves of only the first valve arrangement;
the head-end of the second actuator is fluidly connected in parallel to the first supply and first drain valves of the second and third valve arrangements; and
the rod-end of the second actuator is fluidly connected in parallel to the second supply and second drain valves of only the second valve arrangement.

8. The hydraulic system of claim 6, wherein one of the first and second supply valves of the third valve arrangement is configured to open during opening of one of the first and second supply valves of the first valve arrangement to facilitate supplemental flow from the pump to the first actuator.

9. The hydraulic system of claim 6, wherein one of the first and second drain valves of the third valve arrangement is configured to open during opening of one of the first and second drain valves of the first valve arrangement to facilitate supplemental flow from the first actuator to the tank.

10. The hydraulic system of claim 6, wherein both of the first and second supply valves of the third valve arrangement are configured to open during simultaneous opening of one of the first and second supply valves of the first valve arrangement and one of the first and second drain valves of the second valve arrangement to facilitate fluid regeneration from the first actuator to the second actuator.

11. The hydraulic system of claim 10, wherein both of the first and second drain valves of the first valve arrangement and both of the first and second supply valves of the second valve arrangement are configured to at least partially close during fluid regeneration from the first actuator to the second actuator.

12. The hydraulic system of claim 6, wherein both of the first and second supply valves of the first valve arrangement are configured to open and both of the first and second drain valves of the first valve arrangement are configured to at least partially close during fluid regeneration from the first actuator to the first actuator.

13. The hydraulic system of claim 1, further including:
a first pressure compensator disposed between the pump and the first valve arrangement;
a second pressure compensator disposed between the pump and the second valve arrangement; and
a third pressure compensator disposed between the pump and the third valve arrangement;

14. A method of operating a hydraulic system, comprising:
pressurizing a fluid;
directing a first flow of the pressurized fluid to move a first actuator;
directing a second flow of the pressurized fluid to move a second actuator;
directing a third flow of the pressurized fluid in parallel with at least one of the first and second flows of pressurized fluid to move at least one of one of the first and second actuators at an increased velocity; and
directing pressurized fluid from the first actuator to the second actuator.

15. The method of claim 14, further including directing pressurized fluid from the first actuator to the first actuator.

16. The method of claim 15, wherein the directing of pressurized fluid from the first actuator to the first actuator only occurs when the first actuator is moving in a direction substantially aligned with gravity.

17. The method of claim 16, wherein when directing pressurized fluid from the first actuator to the first actuator, the first flow of pressurized fluid is at least partially blocked from the first actuator.

18. The method of claim 14, wherein when directing pressurized fluid from the first actuator to the second actuator, the second flow of pressurized fluid is at least partially blocked from the second actuator.

19. The method of claim 14, further including:
directing a first flow of fluid from the first actuator to a low pressure reservoir to facilitate movement of the first actuator;
directing a second flow of fluid from the second actuator to the low pressure reservoir to facilitate movement of the second actuator; and
directing a third flow of fluid from at least one of the first and second actuators in parallel with at least one of the first and second flows of fluid to the low pressure reservoir to facilitate movement of the at least one of the first and second actuators at an increased velocity.

20. A machine, comprising:
an engine;
a pump driven by the engine to pressurize fluid;
a tank;
a tool;
a linkage system configured to move the tool;
a first actuator configured to affect movement of the linkage system;
a first valve arrangement configured to control fluid flow from the pump to the first actuator and from the first actuator to the tank;
a second actuator configured to affect movement of the linkage system;
a second valve arrangement configured to control fluid flow from the pump to the second actuator and from the second actuator to the tank; and
a third valve arrangement fluidly connected between the first and second valve arrangements and connected to receive pressurized fluid from the pump in parallel with the first and second valve arrangements, the third valve arrangement being configured to facilitate fluid regeneration of and supplemental flow to at least one of the first and second actuators.
